(19) United States
(12) Patent Application Publication
(10) Pub. No.: US 2022/0238880 A1
(43) Pub. Date: Jul. 28, 2022

(54) Negative Electrode Active Material for Secondary Battery and Secondary Battery Including the Same

(71) Applicant: SK Innovation Co., Ltd., Seoul (KR)

(72) Inventors: Hae Suk Hwang, Daejeon (KR); Mi Ryeong Lee, Daejeon (KR); Hee Gyoung Kang, Daejeon (KR); Jong Hyuk Lee, Daejeon (KR)

(21) Appl. No.: 17/582,138

(22) Filed: Jan. 24, 2022

(30) Foreign Application Priority Data
Jan. 25, 2021 (KR) 10-2021-0009893

(51) Int. Cl. H01M 4/583; H01M 10/0525

(52) U.S. Cl. CPC H01M 4/583; H01M 2004/027; H01M 10/0525

(57) ABSTRACT

Provided is a negative electrode active material for a secondary battery including a carbon-based active material. The negative electrode active material satisfies the following Relational Expression 1, [Relational Expression 1] 0.1≤(Dₚ−D_{T})/sphericity≤0.28 where Dₚ is a pellet density (g/cm³) of the carbon-based active material, D_{T} is a tap density (g/cm³) of the carbon-based active material, and the sphericity is a sphericity of a particle of the carbon-based active material.

### CROSS-REFERENCE TO RELATED APPLICATION

This application claims priority to Korean Patent Application No. 10-2021-0009893 filed Jan. 25, 2021, the disclosure of which is hereby incorporated by reference in its entirety.

### BACKGROUND OF THE INVENTION

### Field of the Invention

The following disclosure relates to a negative electrode active material for a secondary battery and a secondary battery including the same.

### Description of Related Art

Global warming issues in modern society and the demand for eco-friendly technologies as a response to the issues have rapidly increased. In particular, in accordance with an increase in technical demand for an electric vehicle and an energy storage system (ESS), the demand for a lithium secondary battery, which has been spotlighted as an energy storage device, has also exploded. Accordingly, studies on improvement of output and lifespan characteristics of a lithium secondary battery have been conducted.

Meanwhile, in the related art, lithium metal has been used as a negative electrode for a lithium secondary battery. However, since a battery short circuit may occur due to formation of dendrites and there is a risk of explosion due to the short circuit, the use of a carbon-based active material capable of reversibly intercalating and deintercalating lithium ions and maintaining structural and electrical properties has emerged.

In a rolling process for producing an electrode for a lithium secondary battery, in the case of using the carbon-based active material, particles are severely deformed, resulting in intensification of a side reaction with an electrolyte and deterioration of lifespan characteristics of the lithium secondary battery.

Therefore, there is a need to develop a carbon-based active material capable of minimizing a mechanical stress during electrode rolling to solve the above problems and improve lifespan characteristics of the lithium secondary battery.

### SUMMARY OF THE INVENTION

An embodiment of the present invention is directed to improve lifespan characteristics of a secondary battery by providing a material and an electrode that may minimize deformation of particles of a negative electrode active material occurring during a rolling process for producing a negative electrode.

In one general aspect, a negative electrode active material for a secondary battery includes a carbon-based active material, wherein the negative electrode active material satisfies the following Relational Expression 1,

0.1≤(Dₚ−D_{T})/sphericity≤0.28 [Relational Expression 1]

wherein Dₚ is a pellet density (g/cm³) of the carbon-based active material, D_{T} is a tap density (g/cm³) of the carbon-based active material, and the sphericity is a sphericity of a particle of the carbon-based active material.

The negative electrode active material may further satisfy the following Relational Expression 2,

Dₚ−D_{T}<0.3 [Relational Expression 2]

wherein Dₚ is a pellet density (g/cm³) of the carbon-based active material and D_{T} is a tap density (g/cm³) of the carbon-based active material.

The sphericity of the particle of the carbon-based active material may be 0.8 to 1.

The pellet density (Dₚ) of the carbon-based active material may be 1.0 to 1.5 g/cm³.

The carbon-based active material may be natural graphite or artificial graphite.

A Raman R value of the negative electrode active material may be 0.01 to 1.4, the Raman R value being represented by the following Equation 1,

Raman R=Id/Ig [Equation 1]

wherein the Raman R value is an index indicating a relative sphericity, and is calculated as a ratio of an intensity value of a peak in an absorption region of 1,350 to 1,380 cm⁻¹ (Id) to an intensity value of a peak in an absorption region of 1,580 to 1,600 cm⁻¹ (Ig) in Raman spectroscopy.

The negative electrode active material may further include one or more selected from the group consisting of hard carbon and soft carbon.

The amount of one or more selected from the group consisting of hard carbon and soft carbon included in the negative electrode active material may be 5 to 15 wt % with respect to a total weight of the negative electrode active material.

In another general aspect, a negative electrode for a secondary battery includes the negative electrode active material according to one aspect of the present invention.

In still another general aspect, a secondary battery includes the negative electrode according to one aspect of the present invention, a positive electrode, a separator interposed between the negative electrode and the positive electrode, and an electrolyte.

Other features and aspects will be apparent from the following detailed description, the drawings, and the claims.

### DESCRIPTION OF THE INVENTION

The advantages and features of the present invention and methods accomplishing them will become apparent from exemplary embodiments described in detail with the accompanying drawings. However, the present invention is not limited to exemplary embodiments to be described below, but may be implemented in various different forms, these exemplary embodiments will be provided only in order to make the present invention complete and allow those skilled in the art to completely recognize the scope of the present invention, and the present invention will be defined by the scope of the claims. Specific contents for implementing the present invention will be described in detail with reference to the accompanying drawings. The same reference numerals refer to the same components regardless of the drawings. The term “and/or” includes any and all combinations of one or more of the listed items.

Unless defined otherwise, all terms (including technical and scientific terms) used in the present specification have the same meanings as commonly understood by those skilled in the art to which the present invention pertains. Throughout the present specification, unless explicitly described to the contrary, “comprising” any components will be understood to imply further inclusion of other components rather than the exclusion of any other components. In addition, the singular forms are intended to include the plural forms, unless the context clearly indicates otherwise.

In the present specification, it will be understood that when an element such as a layer, a film, a region, a plate, or the like, is referred to as being “on” or “above” another element, it may be directly on another element or may have an intervening element present therebetween.

The present invention provides a negative electrode active material for a secondary battery including a carbon-based active material, wherein the negative electrode active material satisfies the following Relational Expression 1,

0.1≤(Dₚ−D_{T})/sphericity≤0.28 [Relational Expression 1]

wherein Dₚ is a pellet density (g/cm³) of the carbon-based active material, D_{T} is a tap density (g/cm³) of the carbon-based active material, and the sphericity is a sphericity of a particle of the carbon-based active material.

The pellet density (Dₚ) of the carbon-based active material is a pellet density measured by pressurizing the carbon-based active material at 2 ton/cm². Specifically, the pellet density (Dₚ) of the carbon-based active material may be calculated through the following relational expression by injecting 1 g (W) of a carbon-based active material into a circular mold of a pelletizer having a diameter of 13 mm (D), pressurizing the carbon-based active material at 2 metric tons for 10 seconds, releasing the pressure, and then measuring a height (H2) of the pelletizer.

Dₚ=W/[π×(D/2)²×(H₂−H₁)/1,000]

wherein W is an injection amount (g) of the carbon-based active material, D is a diameter (mm) of the mold of the pelletizer, and H₁ and H₂ are heights (mm) of the pelletizer before and after the pressurization, respectively.

The tap density (D_{T}) of the carbon-based active material may be measured using a tap denser (Autotap, Quantachrome Instruments). Specifically, a tap density may be measured from a volume and weight of a carbon-based active material by filling a 25 ml measuring cylinder with 10 g of the carbon-based active material and then performing a tap having a stroke length of 10 mm 3,000 times.

The sphericity of the particle of the carbon-based active material may be measured using a particle shape analyzer (Sysmex FPIA3000, Malvern Panalytical Ltd.). Specifically, the sphericity is a value obtained by dividing a circumference of a circle having the same area as that of a projected image of a carbon-based active material sample by a perimeter of the projected image of the sample. The sphericity may be calculated by the following calculation formula. Here, the sphericity is expressed as an average value of ten sphericity values arbitrarily selected from the carbon-based active material.

Sphericity=(circumference of circle having the same area as that of projected image of particle of carbon-based active material)/(perimeter of projected image of particle of carbon-based active material)

The negative electrode active material includes the carbon-based active material satisfying Relational Expression 1, such that the deformation of the active material and pore clogging due to the deformation of the active material occurring during a rolling process may be suppressed to impregnate a negative electrode with an electrolyte, compared to a case where the negative electrode active material includes a carbon-based active material that does not satisfy Relational Expression 1. Therefore, lifespan characteristics of a lithium secondary battery may be significantly improved.

In the negative electrode active material for a secondary battery according to an exemplary embodiment of the present invention, the pellet density (Dₚ) and the tap density (D_{T}) of the carbon-based active material may further satisfy the following Relational Expression 2.

Dₚ−D_{T}<0.3 [Relational Expression 2]

In a range in which the pellet density and the tap density of the carbon-based active material satisfy Relational Expression 2, the deformation of the particles of the carbon-based active material occurring during a negative electrode rolling process may be minimized, resulting in suppression of exposure of internal graphite of the active material that may cause a side reaction with an electrolyte. Therefore, the lifespan characteristics of the lithium secondary battery may be improved.

More specifically, the Dₚ−D_{T} value may be 0.10 to 0.28.

Thus, when both Relational Expressions 1 and 2 are satisfied, a low resistance and lifespan characteristics of the lithium secondary battery may be more significantly implemented.

These improvements are also confirmed by comparing Examples and Comparative Examples of the present invention. In a case where the negative electrode active material includes a carbon-based active material satisfying both Relational Expressions 1 and 2, a resistance is reduced and a capacity retention rate of the lithium secondary battery is improved compared to a case where a carbon-based active material does not satisfy both Relational Expressions 1 and 2.

Specifically, in Examples of the present invention, after battery assembly, a resistance after charging and discharging is 1.35 Ohm, which is significantly low, and a capacity retention rate after repeated charging and discharging 1,000 times is 95% or more, which shows that the lifespan characteristics of the lithium secondary battery are significantly excellent.

In the negative electrode active material for a secondary battery according to an exemplary embodiment of the present invention, the pellet density (Dₚ) of the carbon-based active material may be 1.0 to 1.5 g/cm³, preferably 1.3 to 1.5 g/cm³, and more preferably 1.3 to 1.4 g/cm³. Within the above range, the deformation of the particles of the carbon-based active material during the rolling process in a process of producing a negative electrode is not large, such that an increase in diffusion resistance due to expansion of a diffusion path of lithium ions may be suppressed.

In the negative electrode active material for a secondary battery according to an exemplary embodiment of the present invention, the sphericity of the carbon-based active material may be 0.8 to 1, and preferably 0.9 to 1. Within the above range, it is possible to suppress a phenomenon in which a voltage and a current are not uniformly distributed due to an increase in anisotropy of the particle of the carbon-based active material. Therefore, an increase in resistance and a reduction in capacity may be reduced.

In the negative electrode active material for a secondary battery according to an exemplary embodiment of the present invention, the carbon-based active material may be a crystalline carbon-based material, and specifically, may be natural graphite or artificial graphite. More specifically, the carbon-based active material may be artificial graphite. The artificial graphite may be preferred because it has a high particle hardness and thus may implement production of an electrode having a high density, which may increase a capacity density per volume of the negative electrode and contribute to improvement of the lifespan characteristics of the battery. However, the present invention is not limited thereto.

A Raman R value of the negative electrode active material for a secondary battery according to an exemplary embodiment of the present invention may be 0.01 to 1.4, preferably 0.01 to 0.6, and more preferably 0.01 to 0.4, the Raman R value being represented by the following Equation 1. Therefore, a discharge capacity and lifespan characteristics of the secondary battery may be further improved.

Raman R=Id/Ig [Equation 1]

wherein the Raman R value is an index indicating a relative sphericity, and is calculated as a ratio of an intensity value of a peak in an absorption region of 1,350 to 1,380 cm⁻¹ (Id) to an intensity value of a peak in an absorption region of 1,580 to 1,600 cm⁻¹ (Ig) in Raman spectroscopy.

The negative electrode active material for a secondary battery according to an exemplary embodiment of the present invention may include one or more selected from the group consisting of hard carbon and soft carbon in an amount of 5 to 15 wt %, and preferably 6 to 12 wt %. Within the above range, the hard carbon or soft carbon may act as a support in the negative electrode active material, such that the deformation of the particles of the carbon-based active material occurring during the rolling process for producing the negative electrode may be minimized. Therefore, the resistance of the secondary battery may be reduced.

The present invention also provides a negative electrode for a secondary battery including the negative electrode active material according to an exemplary embodiment of the present invention. Specifically, the negative electrode includes a current collector, the negative electrode active material disposed on the current collector, and a negative electrode active material layer including a conductive material and a binder.

The current collector may be selected from the group consisting of a copper foil, a nickel foil, a stainless steel foil, a titanium foil, a nickel foam, a copper foam, a polymer substrate coated with a conductive metal, and a combination thereof, but the present invention is not limited thereto.

The binder is not particularly limited as long as it is a conventional binder capable of well adhering the electrode active material to the current collector while well adhering the particles of the electrode active material to each other. As an example, the binder may be an aqueous binder, and specifically, may be styrene-butadiene rubber, acrylate styrene-butadiene rubber, polyvinyl alcohol, sodium polyacrylate, a copolymer of propylene and an olefin having 2 to 8 carbon atoms, a copolymer of (meth)acrylic acid and (meth)acrylic acid alkyl ester, or a combination thereof.

When the aqueous binder described above is used, the aqueous binder may bind the electrode active material to the current collector well without affecting a viscosity of a slurry, which is preferable. However, the slurry may be easily gelled due to the electrode active material and the conductive material that are fine particles. Accordingly, the negative electrode may further include a thickener for making a stable slurry by imparting the viscosity to the slurry. As an example, a cellulose-based compound, specifically, carboxymethyl cellulose, hydroxypropylmethyl cellulose, methyl cellulose, or a mixture of one or more salts of alkali metals thereof may be used as the thickener. Na, K, or Li may be used as the alkali metal.

The conductive material may be used for imparting conductivity to the electrode. The conductive material may be not particularly limited as long as it is a conductive material without causing chemical changes in a battery. Examples of the conductive material include a carbon-based material such as natural graphite, artificial graphite, carbon black, acetylene black, Ketjenblack, or a carbon fiber; a metal-based material of a metal powder or a metal fiber such as copper, nickel, aluminum, or silver; a conductive polymer such as a polyphenylene derivative; and a conductive material including a mixture thereof.

The present invention also provides a secondary battery including the negative electrode, a positive electrode, a separator interposed between the negative electrode and the positive electrode, and an electrolyte.

The negative electrode is the same as described above.

The positive electrode includes a current collector and a positive electrode active material layer formed by applying a positive electrode slurry containing a positive electrode active material on the current collector.

The negative electrode current collector may be used as the current collector, and any material known in the art may be used. However, the present invention is not limited thereto.

The positive electrode active material layer may include a positive electrode active material, and may optionally further include a binder and a conductive material. A positive electrode active material known in the art may be used as the positive electrode active material. It is preferable that a composite oxide of lithium and a metal selected from cobalt, manganese, nickel, and a combination thereof is used as the positive electrode active material. However, the present invention is not limited thereto.

The negative electrode binder and the negative electrode conductive material described above may be used the binder and the conductive material, and any material known in the art may be used. However, the present invention is not limited thereto.

The separator may be selected from a glass fiber, polyester, polyethylene, polypropylene, polytetrafluoroethylene, or a combination thereof, and may be in a form of a nonwoven fabric or a woven fabric. In a lithium secondary battery, for example, a polyolefin-based polymer separator such as polyethylene or polypropylene may be mainly used, a separator coated with a composition containing a ceramic component or a polymer material may be used to secure heat resistance and mechanical strength, a separator having a single layer or multilayer structure may be selectively used, or a separator known in the art may be used. However, the present invention is not limited thereto.

The electrolyte includes an organic solvent and a lithium salt.

The organic solvent functions as a medium through which ions involved in an electrochemical reaction of the battery may move. For example, a carbonate-based solvent, an ester-based solvent, an ether-based solvent, a ketone-based solvent, an alcohol-based solvent, or an aprotic solvent may be used. The organic solvents may be used alone or a mixture of two or more thereof. When a mixture of two or more organic solvents is used, a mixing ratio may be appropriately adjusted according to a desired battery performance. Meanwhile, an organic solvent known in the art may be used, but the present invention is not limited thereto.

The lithium salt is a material that is dissolved in the organic solvent to act as a supply source of the lithium ions in the battery, enables a basic operation of the lithium secondary battery, and serves to promote movement of the lithium ions between the positive electrode and the negative electrode. Examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂) (CyF_{2y+1}SO₂) (x and y are natural numbers), LiCl, LiI, LiB(C₂O₄)₂, and a combination thereof. However, the present invention is not limited thereto.

A concentration of the lithium salt may be within a range of 0.1 M to 2.0 M. When the concentration of the lithium salt is within the above range, the electrolyte has appropriate conductivity and viscosity, and thus, an excellent performance of the electrolyte may be exhibited and the lithium ions may effectively move.

In addition, in order to improve charging and discharging characteristics, flame retardancy properties, and the like, the electrolyte may further include pyridine, triethyl phosphate, triethanolamine, cyclic ether, ethylene diamine, n-glyme, hexaphosphoric acid triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, aluminum trichloride, and the like, if necessary. In some cases, in order to impart noninflammability, the electrolyte may further include a halogen-containing solvent such as carbon tetrachloride or trifluoroethylene, and in order to improve high-temperature storage characteristics, the electrolyte may further include fluoro-ethylene carbonate (FEC), propene sulfone (PRS), fluoro-propylene carbonate (FPC), and the like.

### EXAMPLES

### Example 1

Step 1: Production of Negative Electrode Active Material

Flake graphite was injected into a continuous grinding classifier to obtain spherical natural graphite, the spherical natural graphite was subjected to an acid treatment at 80° C. for 12 hours using sulfuric acid, hydrochloric acid, and nitric acid, and the spherical natural graphite was subjected to a washing and drying process, thereby obtaining spherical natural graphite with a final purity of 99.8%. In this case, D50 and an average specific surface area of the spherical natural graphite were 10 μm and 10 m²/g, respectively.

The high-purity spherical natural graphite and pitch were mixed in a weight ratio of 95:5, coating was performed using a blade mill for 30 minutes, and the mixture was fired using a roller hearth kiln (RHK) at 1,200° C. under a nitrogen atmosphere for 12 hours. Subsequently, a classification process and an iron removing process were performed to produce pitch-coated natural graphite particles having D50 of 10 μm and an average specific surface area of 3.0 m²/g.

Next, fine powder and coarse powder were removed through particle sieving to adjust a particle size distribution, and values of a tap density, a pellet density, and a sphericity were adjusted as shown in Table 1. The natural graphite and hard carbon were mixed in a weight ratio of 9:1 to produce a negative electrode active material.

Step 2: Production of Negative Electrode

Water was added to 93.4 wt % of the negative electrode active material, 3.0 wt % of a carbon black conductive agent, 2.4 wt % of an SBR binder, and 1.2% of CMC, and mixing was performed at room temperature for 120 minutes, thereby producing a slurry. The produced slurry was applied and dried on a Cu foil current collector, and rolling was performed so that a density of a negative electrode mixture was 1.7 g/cc, thereby producing a negative electrode.

Step 3: Production of Half Cell

A PE separator was interposed between the produced negative electrode, a lithium metal positive electrode, a negative electrode, and a positive electrode, and an electrolyte was injected to produce a CR2016 coin cell. The assembled coin cell was rested at room temperature for 24 hours to produce a half cell. In this case, a mixture obtained by mixing a lithium salt (1.0 M LiPF₆) with an organic solvent (EC:EMC=3:7 vol %) and an electrolyte additive FEC (2 vol %) was used as the electrolyte.

Evaluation of Physical Properties

1) Measurement of Tap Density (D_{T}) of Natural Graphite

A 25 ml measuring cylinder was charged with 10 g of a sample (natural graphite of each of Examples 1 to 3 and Comparative Examples 1 and 2), a tap having a stroke length of 10 mm was performed 3,000 times, and then, a tap density was measured from the volume and weight of the sample. The measurement was performed three times to calculate an average value of the tap densities. The results thereof are shown in Table 1. In this case, it was confirmed that the value was within ±1% of an error range of each measurement.

2) Measurement of Pellet Density (Dₚ) of Natural Graphite

A pellet density was obtained by measuring a change in volume when a sample (natural graphite of each of Examples 1 to 3 and Comparative Examples 1 to 5) was added to a vessel and the sample was pressurized at a certain pressure. The change in volume was measured by pressurizing 1±0.1 g of the sample at 2.0 metric tons, and then, the pellet density of the sample was calculated. The results thereof are shown in Table 1. A pellet density measurement method and calculation formula are as follows.

[Pellet Density Measurement Method]

a) A height of an empty pelletizer is measured. (Height gauge, H₁, mm)

b) About 1±0.1 g (W, g) of a sample is injected into a sample inlet of the pelletizer, and the sample is carefully injected so that it does not flow down or leak out the pelletizer.

c) The pelletizer is placed in the center of a manual type presser.

d) A lever of the manual type presser is pulled to apply a pressure while checking the gauge until the mass reaches 2.0 metric tons.

e) The pressure is released after 10 seconds of the pressurization. Thereafter, the pelletizer is carefully removed and a height thereof is measured. (H₂, mm)

[Pellet Density Calculation Formula]

Pellet density=W/[π×(13/2)²×(H₂−H₁)/1,000],Diameter of hole of pelletizer:13 mm

3) Measurement of Sphericity of Natural Graphite

A sphericity of a sample (natural graphite of each of Examples 1 to 3 and Comparative Examples 1 to 5) was measured using a particle shape analyzer (Sysmex FPIA3000, Malvern Panalytical Ltd.). The results thereof are shown in Table 1. The sphericity is a value obtained by dividing a circumference of a circle having the same area as that of a projected image of the sample by a perimeter of the projected image of the sample. The sphericity was calculated by the following calculation formula. In this case, the sphericity was expressed as an average value of ten sphericity values arbitrarily selected from the negative electrode active material.

Sphericity=(circumference of circle having the same area as that of projected image of natural graphite particle)/(perimeter of projected image of natural graphite particle)

### Evaluation Examples

### Evaluation Example 1: Evaluation of Output Resistance and Lifespan Characteristics of Half Cell

### Examples 2 and 3 and Comparative Examples 1 to 5

A half cell was produced in the same manner described above, except that the negative electrode was produced using a negative electrode active material including natural graphite having the pellet density, the sphericity, and the tap density shown in Table 1.

The half cell produced in each of Examples 1 to 3 and Comparative Examples 1 to 5 was charged and discharged at a low controlled rate (0.1 C) during initial 3 to 5 cycles to stabilize the electrode, and then, the half cell was charged and discharged at a rate of 1 C. A capacity retention rate during 100 cycles with respect to a discharge capacity in the first cycle is shown in Table 1. In this case, in the discharge process during 4 cycles, a resistance at a point of time when the state of charge (SOC) was 50% was measured using TOSCAT-3100 (TOYO SYSTEM Co., Ltd.). The results thereof are shown in Table 1.

TABLE 1

| | | | Relational | | Relational | | Capacity |
|---|---|---|---|---|---|---|---|
| | | | Expression | | Expression | DC | retention |
| | Dₚ | D_{T} | 2 | | 1 (Dₚ-D_{T})/ | IR | rate |
| | (g/cm³) | (g/cm³) | Dₚ-D_{T} | Sphericity | sphericity | (Ohm) | (%) |
| Example 1 | 1.32 | 1.20 | 0.12 | 0.97 | 0.12 | 1.31 | 96 |
| Example 2 | 1.32 | 1.05 | 0.27 | 0.96 | 0.28 | 1.32 | 97 |
| Example 3 | 1.34 | 1.12 | 0.22 | 0.96 | 0.23 | 1.32 | 95 |
| Comparative | 1.32 | 0.99 | 0.33 | 0.93 | 0.35 | 1.40 | 89 |
| Example 1 | | | | | | | |
| Comparative | 1.32 | 1.04 | 0.28 | 0.94 | 0.30 | 1.43 | 88 |
| Example 2 | | | | | | | |
| Comparative | 1.49 | 1.18 | 0.31 | 0.96 | 0.32 | 1.50 | 87 |
| Example 3 | | | | | | | |
| Comparative | 1.32 | 1.05 | 0.27 | 0.78 | 0.35 | 1.55 | 86 |
| Example 4 | | | | | | | |
| Comparative | 1.59 | 1.32 | 0.27 | 0.80 | 0.45 | 1.51 | 85 |
| Example 5 | | | | | | | |

Referring to Table 1, it could be confirmed that in Examples in which both Relational Expressions 1 and 2 of the present invention were satisfied, the resistances and capacity retention rates were significantly improved compared to those in Comparative Examples in which both Relational Expressions 1 and 2 of the present invention were not satisfied. Meanwhile, it was appreciated in Example 3 that the pellet density was higher than those in Examples 1 and 2, which showed that the resistance and capacity retention rate performance was relatively reduced.

It was confirmed in Comparative Example 3 that the resistance was high and the capacity retention rate was deteriorated because Relational Expressions 1 and 2 were not satisfied due to the high pellet density.

In Comparative Examples 4 and 5, Relational Expression 1 of the present invention was not satisfied, an increase in anisotropy of the particle was increased due to the low sphericity of the particle of the natural graphite, resulting in an increase in resistance and a reduction in capacity retention rate due to non-uniform voltage and current distribution.

### Evaluation Example 2: Raman Spectrum Analysis of Negative Electrode Active Material and Evaluation of Performance of Half Cell

### Examples 4 to 7

A negative electrode active material was produced in the same manner as that of Example 2, except that the negative electrode active material composition as shown in Table 2 was applied.

### Comparative Example 6

A negative electrode active material was produced in the same manner as that of Comparative Example 2, except that the negative electrode active material composition as shown in Table 2 was applied.

In the Raman spectrum analysis, Invia confocal Raman microscope (Renishaw plc. (UK)) was used, a laser wavelength was 532 nm, a lens magnification was 50 times, an average value was applied by measuring the particle surface eight times in a range of 67 to 1,800 cm⁻¹ in a static mode.

Meanwhile, in the analysis method of the Raman spectrum, the Raman R value (Id/Ig) as a ratio of an intensity value of a peak in an absorption region of 1,350 to 1,380 cm⁻¹ (Id) to an intensity value of a peak in an absorption region of 1,580 to 1,600 cm⁻¹ (Ig) in Raman spectroscopy may indicate the sphericity of the negative electrode active material. The results of the Raman analysis of the negative electrode active materials produced in Examples 2 and 4 to 7 and Comparative Examples 2 and 5 are shown in Table 2.

The resistance and the capacity retention rate were measured in the same manner as that of Evaluation Example 1 using the half cell produced in each of Examples 2 and 4 to 7 and Comparative Examples 2 and 6. An average discharge capacity during 100 cycles was calculated. The calculated average discharge capacities are shown in Table 2.

TABLE 2

| | Evaluation | | Evaluation | | |
|---|---|---|---|---|---|
| | of negative electrode | | of performance | | |
| | active material | | of half cell | | |
| | Negative | | | | Ca- |
| | electrode | | | Dis- | pacity |
| | active material | | | charge | reten- |
| | composition | | DC IR | capacity | tion |
| | (wt %) | I_{D}/I_{G} | (Ohm) | (mAh/g) | rate (%) |
| Example 2 | Natural | 0.7 | 1.32 | 315 | 97 |
| | graphite (90), | | | | |
| | hard carbon (10) | | | | |
| Example 4 | Natural | 0.3 | 1.40 | 320 | 96 |
| | graphite (100) | | | | |
| Example 5 | Natural | 0.9 | 1.29 | 299 | 95 |
| | graphite (80), | | | | |
| | hard carbon (20) | | | | |
| Example 6 | Natural | 0.5 | 1.30 | 316 | 89 |
| | graphite (95), | | | | |
| | SWCNT (5) | | | | |
| Comparative | Natural | 0.7 | 1.43 | 313 | 88 |
| Example 2 | graphite (90), | | | | |
| | hard carbon (10) | | | | |
| Comparative | Natural | 0.8 | 1.35 | 309 | 92 |
| Example 6 | graphite (80), | | | | |
| | hard carbon (20) | | | | |

Referring to Table 2, in Example 2 in which both Relational Expressions 1 and 2 of the present invention were satisfied and the natural graphite and the hard carbon were mixed in a weight ratio of 9:1, the discharge capacity and the capacity retention rate were high.

Meanwhile, in Example 4 in which hard carbon was not included, the discharge capacity properties were similar to those in Example 2, but it was determined that the resistance was increased due to no lithium adsorption process by hard carbon during the charging and discharging process. In addition, in Example 5, the content of hard carbon was relatively large, the resistance properties were excellent, but it was determined that the discharge capacity was reduced due to the reduction in capacity properties.

In Example 6, it was determined that the amount of electrolyte consumed during the charging and discharging process was increased due to the increase of the specific surface area according to the addition of SWCNT to the negative electrode active material, and thus, the long-term lifespan characteristics were reduced.

In Comparative Examples 2 and 6, it was determined that the particles of the natural graphite were severely deformed during the rolling process because Relational Expression 1 of the present invention was not satisfied, and thus, the resistance was high and the capacity retention rate was low compared to Example 2 even in the case where the hard carbon was included in an amount two times the amount of hard carbon in Example 2 (Comparative Example 6).

As set forth above, in the negative electrode active material for a secondary battery according to the present invention, the deformation of the particles occurring during the rolling process may be suppressed, and the capacity and performance of the secondary battery may thus be excellent.

In addition, the phenomenon such as the pore clogging in the negative electrode due to the deformation of the particles of the negative electrode active material may be suppressed. Therefore, the reduction in lifespan due to the occurrence of the side reaction with the electrolyte may be suppressed.

Although the present invention has been described with reference to the exemplary embodiments and the accompanying drawings, it is not limited to the above-mentioned exemplary embodiments but may be variously modified and changed from the above description by those skilled in the art to which the present invention pertains. Therefore, the technical idea of the present invention should be understood only by the following claims, and all of the equivalences and equivalent modifications to the claims are intended to fall within the scope of the technical idea of the present invention.

What is claimed is:

1. A negative electrode active material for a secondary battery, comprising a carbon-based active material,
wherein the negative electrode active material satisfies the following Relational Expression 1,
0.1≤(Dₚ−D_{T})/sphericity≤0.28 [Relational Expression 1]
wherein Dₚ is a pellet density (g/cm³) of the carbon-based active material, D_{T} is a tap density (g/cm³) of the carbon-based active material, and the sphericity is a sphericity of a particle of the carbon-based active material.

2. The negative electrode active material of claim 1, wherein the negative electrode active material further satisfies the following Relational Expression 2,
Dₚ−D_{T}<0.3 [Relational Expression 2]
wherein Dₚ is a pellet density (g/cm³) of the carbon-based active material and D_{T} is a tap density (g/cm³) of the carbon-based active material.

3. The negative electrode active material of claim 1, wherein the sphericity of the particle of the carbon-based active material is 0.8 to 1.

4. The negative electrode active material of claim 1, wherein the pellet density (Dₚ) of the carbon-based active material is 1.0 to 1.5 g/cm³.

5. The negative electrode active material of claim 1, wherein the carbon-based active material is natural graphite or artificial graphite.

6. The negative electrode active material of claim 1, wherein a Raman R value of the negative electrode active material is 0.01 to 1.4, the Raman R value being represented by the following Equation 1,
Raman R=Id/Ig [Equation 1]
wherein the Raman R value is an index indicating a relative sphericity, and is calculated as a ratio of an intensity value of a peak in an absorption region of 1,350 to 1,380 cm⁻¹ (Id) to an intensity value of a peak in an absorption region of 1,580 to 1,600 cm⁻¹ (Ig) in Raman spectroscopy.

7. The negative electrode active material of claim 1, further comprising one or more selected from the group consisting of hard carbon and soft carbon.

8. The negative electrode active material of claim 7, wherein the amount of one or more selected from the group consisting of hard carbon and soft carbon comprised in the negative electrode active material is 5 to 15 wt % with respect to a total weight of the negative electrode active material.

9. A negative electrode for a secondary battery, comprising the negative electrode active material of claim 1.

10. A secondary battery comprising:
the negative electrode of claim 9;
a positive electrode;
a separator interposed between the negative electrode and the positive electrode; and
an electrolyte.
